(19) United States
(12) Patent Application Publication
(10) Pub. No.: US 2019/0020221 A1
(43) Pub. Date: Jan. 17, 2019

(54) INDUCTIVE POWER TRANSFER

(71) Applicant: Apple Inc., Cupertino, CA (US)

(72) Inventor: Jeffrey Douglas Louis, Auckland (NZ)

(21) Appl. No.: 16/046,073

(22) Filed: Jul. 26, 2018

Related U.S. Application Data
(63) Continuation of application No. PCT/NZ2017/050006, filed on Jan. 26, 2017.
(60) Provisional application No. 62/341,812, filed on May 26, 2016.
(60) Provisional application No. 62/287,142, filed on Jan. 26, 2016.

(51) Int. Cl. H02J 50/12

(52) U.S. Cl. CPC H02J 50/12; H02J 50/60

(57) ABSTRACT

A method comprising determining a level of control viability for a inductive power transfer system within a predetermined control range; and adjusting the reactance of the inductive power transfer system if the level of control viability within the predetermined control range is below a threshold.

### FIELD

This invention relates generally to inductive power transfer, particularly though not solely, to a method for inductive power transfer.

### BACKGROUND

Electrical converters are found in many different types of electrical systems. Generally speaking, a converter converts a supply of a first type to an output of a second type. Such conversion can include DC-DC, AC-AC and DC-AC electrical conversions. In some configurations a converter may have any number of DC and AC ‘parts’, for example a DC-DC converter might incorporate an AC-AC converter stage in the form of a transformer.

One example of the use of converters is in inductive power transfer (IPT) systems. IPT systems are a well-known area of established technology (for example, wireless charging of electric toothbrushes) and developing technology (for example, wireless charging of handheld devices on a ‘charging mat’ or for power transfer in an industrial or commercial environment, such as in wind turbines).

IPT systems will typically include an inductive power transmitter and an inductive power receiver. The inductive power transmitter includes a transmitting coil or coils, which are driven by a suitable transmitting circuit to generate an alternating magnetic field. The alternating magnetic field will induce a current in a receiving coil or coils of the inductive power receiver.

### SUMMARY

The present invention may provide improved inductive power transfer or which provides the public with a useful choice.

According to an example embodiment there is provided a method comprising:
determining a level of control viability for a inductive power transfer

system within a predetermined control range; and
adjusting the reactance of the inductive power transfer system if the level of control viability within the predetermined control range is below a threshold.

According to another example embodiment there is provided a method of operating an inductive power transceiver when coupled to a second inductive power transceiver; the method comprising:
monitoring a system control function of the first and second inductive power transceivers using predetermined operating parameters;
regulating power transferred through the inductive power transceiver by adjusting the operating point of the system within a predetermined range of the system control function;
adjusting the reactance of the first or second inductive power transceiver if one or more of the predetermined operating parameters exceeding a threshold.

According to another example embodiment there is provided a method comprising:
determining whether a inductive power transfer system exhibits a monotonic control function with a predetermined control range; and
detuning the inductive power transfer system if the control function is non monotonic with the predetermined control range.

According to another example embodiment there is provided a method comprising:
determining whether a inductive power transfer system exhibits a monotonic control function with a predetermined control range; and
detuning the inductive power transfer system if the control function is non monotonic with the predetermined control range.

According to another example embodiment there is provided an inductive power transmitter comprising:
a power transmitter coil;
an adjustable reactance configured to connect to the coil;
a controller configured to determine whether a control function is monotonic a predetermined control range and adjust the reactance if it is not.

According to a further example embodiment there is provided an inductive power receiver comprising:
a power receiver coil;
an adjustable reactance configured to connect to the coil;
a controller configured to determine whether a control function is monotonic a predetermined control range and adjust the reactance if it is not.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any documents in this specification does not constitute an admission that those documents are prior art or form part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 is a block diagram of an inductive power transfer system;

FIG. 2 is a circuit diagram of an example transmitter and receiver;

FIG. 3 is a graph of example frequency responses;

FIG. 4 is a graph of a modified frequency response;

FIG. 5 is a circuit diagram of an example transmitter;

FIG. 6 is a circuit diagram of an example receiver;

FIG. 7 is a flow diagram of a method of controlling a switched capacitor;

FIG. 8 is a graph of frequency responses;

FIG. 9 is a circuit diagram of an example transmitter and receiver;

FIG. 10 is a further graph of frequency responses;

FIG. 11 is a further graph of frequency responses;

FIG. 12 is a further graph of frequency responses; and

FIG. 13 is a circuit diagram of a further example transmitter and receiver.

### DETAILED DESCRIPTION

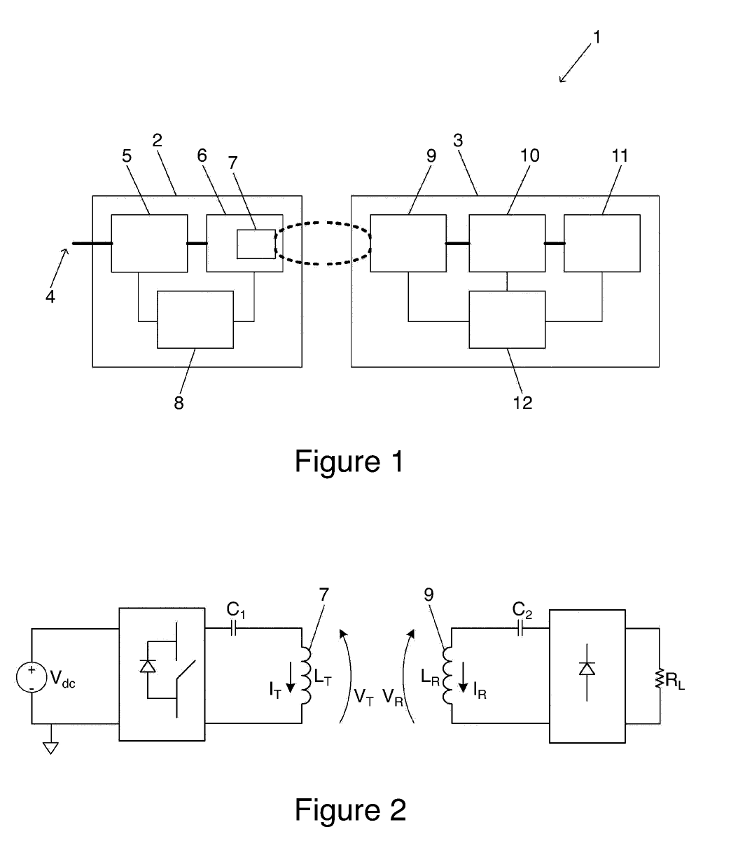

An IPT system 1 is shown generally in FIG. 1. The IPT system includes an inductive power transmitter 2 and an inductive power receiver 3. The inductive power transmitter 2 is connected to an appropriate power supply 4 (such as mains power or a battery). The inductive power transmitter 2 may include transmitter circuitry having one or more of a converter 5, e.g., an AC-DC converter (depending on the type of power supply used) and an inverter 6, e.g., connected to the converter 5 (if present). The inverter 6 supplies a transmitting coil or coils 7 with an AC signal so that the transmitting coil or coils 7 generate an alternating magnetic field. In some configurations, the transmitting coil(s) 7 may also be considered to be separate from the inverter 5. The transmitting coil or coils 7 may be connected to capacitors (not shown) either in parallel or series to create a resonant circuit. Additional coils may be provided, for example in an LCL configuration.

A controller 8 may be connected to each part of the inductive power transmitter 2. The controller 8 may be adapted to receive inputs from each part of the inductive power transmitter 2 and produce outputs that control the operation of each part. The controller 8 may be implemented as a single unit or separate units, configured to control various aspects of the inductive power transmitter 2 depending on its capabilities, including for example: power flow, tuning, selectively energising transmitting coils, inductive power receiver detection and/or communications.

The inductive power receiver 3 includes a power pick up stage 9 connected to power conditioning circuitry 10 that in turn supplies power to a load 11. The power pick up stage 9 includes inductive power receiving coil or coils. When the coils of the inductive power transmitter 2 and the inductive power receiver 3 are suitably coupled, the alternating magnetic field generated by the transmitting coil or coils 7 induces an alternating current in the receiving coil or coils. The receiving coil or coils may be connected to capacitors (not shown) either in parallel or series to create a resonant circuit. Additional coils may be provided, for example in an LCL configuration.

In some inductive power receivers, the receiver may include a controller 12 which may control tuning of the receiving coil or coils, operation of the power conditioning circuitry 10 and/or communications.

The term “coil” may include an electrically conductive structure where an electrical current generates a magnetic field. For example inductive “coils” may be electrically conductive wire in three dimensional shapes or two dimensional planar shapes, electrically conductive material fabricated using printed circuit board (PCB) techniques into three dimensional shapes over plural PCB ‘layers’, and other coil-like shapes. Other configurations may be used depending on the application. The use of the term “coil”, in either singular or plural, is not meant to be restrictive in this sense.

An example circuit for the transmitter and receiver in FIG. 1, is shown in FIG. 2. The inverter 6 supplies an AC voltage across the tuned capacitor C₁ and the transmitting coil L_{T}. L_{T} is coupled to the receiver coil L_{R}, which together with tuned capacitor C₁ supplies an AC voltage to rectifier 10. Rectifier 10 supplies a DC voltage to load R_{L}.

The controller 8 may provide transmitter regulation if required by the application. The form of regulation will depend on the requirements of that application. For example the Wireless Power Consortium (WPC) “Qi” Standard 1.1 requires that a compliance transmitter should regulate power transfer to the receiver, by varying the voltage applied to the transmitting coil in duty cycle, magnitude or frequency.

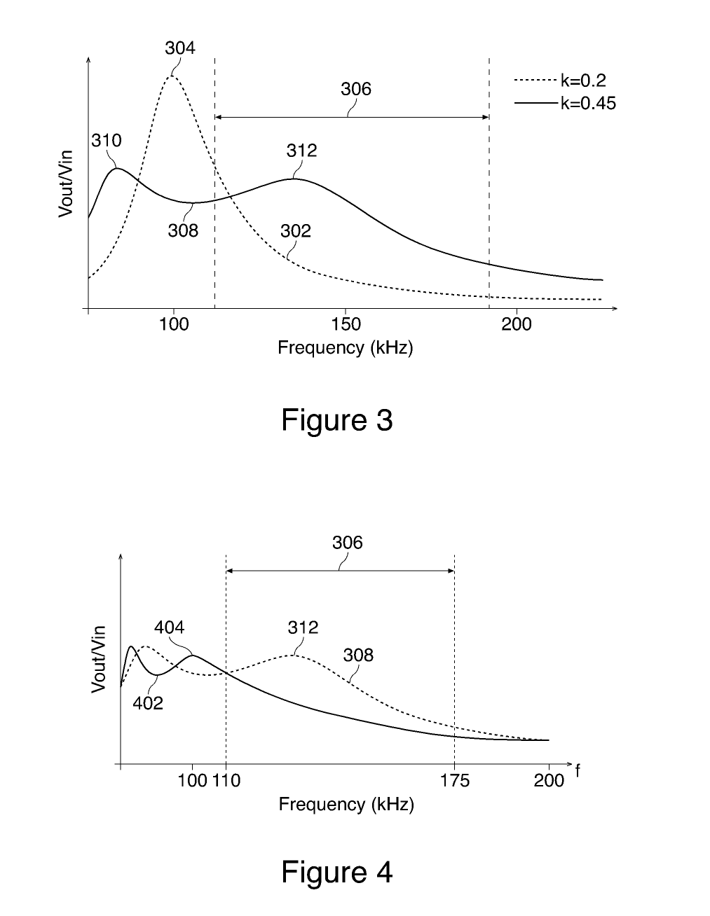

One of the more popular methods is to vary frequency. An example frequency response for the circuit in FIG. 2 is shown in FIGS. 3. In FIG. 3 the first frequency response 302 is similar to a simple high Q resonant circuit with a single peak 304 in the transfer function. In order to implement the system regulation function, typically the frequency operating range 306 of the transmitter will be restricted to the right of the peak 304. By selecting a monotonic (ie entirely increasing or decreasing) region of the transfer function 302, frequency becomes directly related (for example it may be roughly proportional) to the output voltage and/or power transfer and therefore a simple control loop can be used.

The request to regulate the power may be generated by the controller 8 or controller 12. For example the controller 12 may send CEP (Control Error Packet) messages to the transmitter 2 requesting more or less power. In the example above the transmitter 2 would respond to each request by adjusting the frequency down or up by a set amount respectively.

However the transfer function 302 may only correspond to a scenario in FIG. 2 with coupling under a certain threshold or a load current below a threshold. A second frequency response 308 has multiple peaks 310,312 in the transfer function. This second transfer function 308 may correspond to coupling above a certain threshold, load current above a threshold, or low equivalent load resistance, or non-linear phenomena in the ferrite or other magnetic shielding material (used to concentrate flux density within the coil volume).

The double peak resonance phenomena is also a function of the inductance of the receiver, transmitter, and the mutual inductance including the gap between receiver and transmitter coils. A first resonance response peak is due to the circuit loop formed by the receiver coil inductance, a receiver (series or parallel) capacitance, and effective load resistance which determines the receiver's resonant frequency. A second resonance response peak is due to the circuit loop formed by the transmitter coil inductance, transmitter (series or parallel) capacitance, effect of mutual inductance associated with the coupling between transmitter and receiver coils, receiver coil inductance, receiver (series or parallel) capacitance, and the effective load resistance. The system resonance response is formed by the combination of the aforementioned two resonance responses. The system response shape is largely determined by the damping factor or Q factor of each of the two resonance responses, resulting typically in either a single combined broad ‘peak’ (high damping factor or low Q factor), or alternatively two distinct ‘peaks’ (low damping factor or high Q factor) each centred on one of the resonant frequencies associated with each of the aforementioned circuit loops.

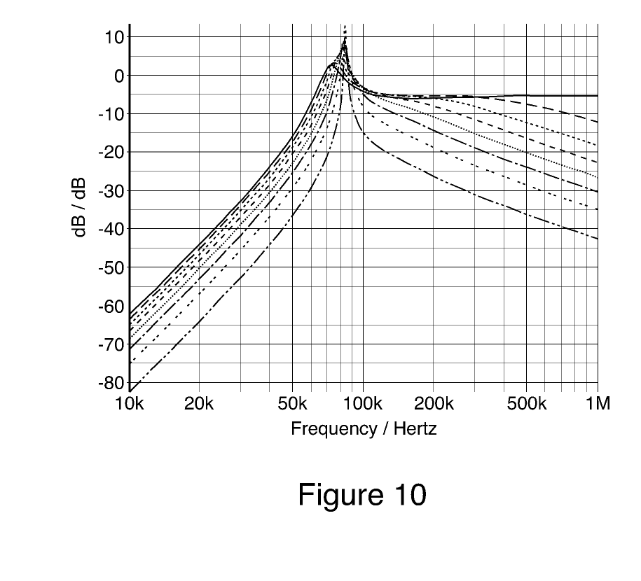

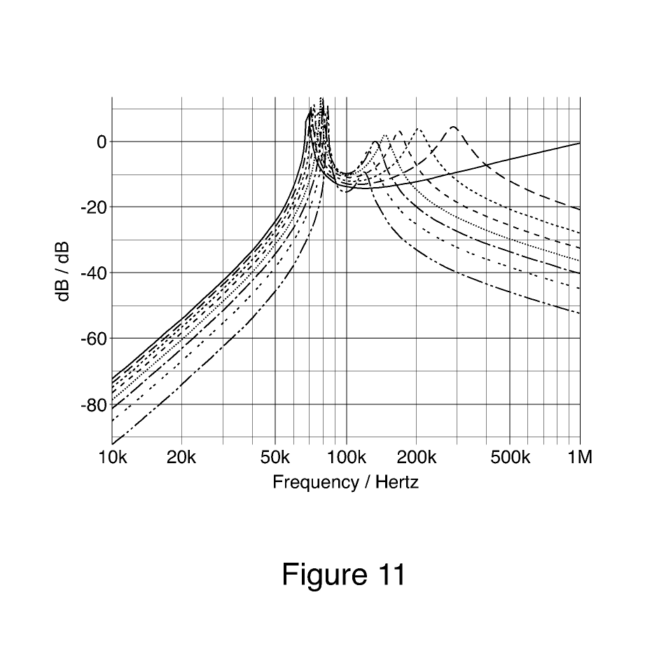

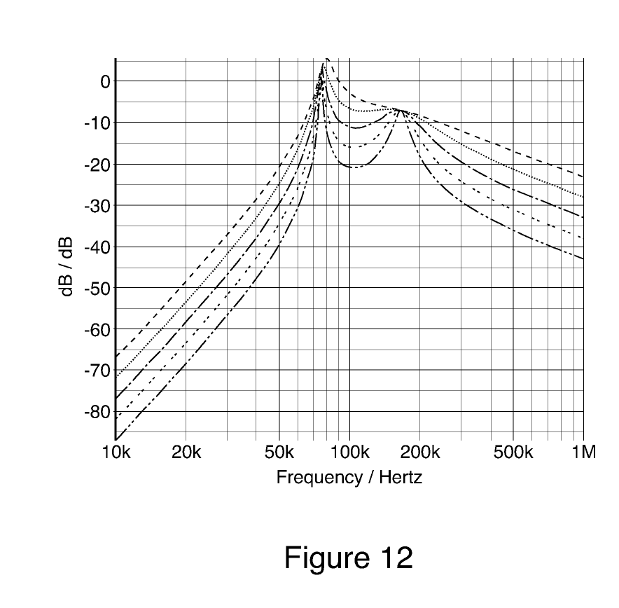

A (SPICE) numerical simulation of a voltage- or power-frequency system gain response of an inductive power transfer (IPT) system having transmitter and receiver is shown in FIG. 10. Responses are shown across a range of coupling factors (ie separation gaps from the transmitter coil) k=0.1 (red)−1.0 (dark blue) for a receiver coil having an inductance of 12 uH, and a fixed load resistance of 10 ohms (at a typically Qi load voltage of 5V this represents 2.5 W of power transfer). As can be seen the shape of the system response curve exhibits a single combined broad peak at a resonant frequency from 70-85 kHz in this example. However a single resonant frequency peak is exhibited as the damping factor of the “second” circuit loop (i.e. formed with the mutual inductance) is relatively high (“low Q”). FIG. 11 shows a similar response curve simulation but where the receiver coil inductance is ten times higher at 120 uH (and the series capacitance is chosen to be ten times lower, for an equivalent resonant frequency) or predetermined control range. The larger receiver coil inductance results in the double peak phenomenon because the damping factor of the “second” circuit loop is relatively low (“high Q”), resulting in a system frequency response with two distinct resonant peaks. FIG. 12 shows an IPT system frequency/gain response where the coupling factor is held constant at 0.6, and the load resistance is varied from 10 ohms (cyan/light blue) to 1 ohm (red) (at 5V resulting in a power transfer range of 2.5 W to 25 W). Again this results in development of the dual peak phenomenon as the damping factor formed by the second circuit loop becomes relatively low (as load resistance decreases). It can be seen that the emergence and extent of the dual peak phenomenon is dependent on the coupling factor k, the receiver load (measurable in power or load current when the load voltage is known/fixed, or effective resistance value), and also the inductance selected for the transmitter and receiver coils. Choosing a lower value of inductance for either or both coils is more resistant to this phenomenon emerging, compared with a higher inductance coil for the same coupling and load conditions.

Referring again to FIG. 3, as a consequence of the transfer function 308, a simple up/down frequency control methodology may fail to reach its desired operating point if the frequency operating range 306 of the transmitter overlaps with the second peak 312—ie the frequency response becomes non-monotonic over the frequency operating range. The controller 8 will expect a negative gradient and will therefore increase frequency if less power/voltage is required by the receiver 3. To the left of peak 312, increased frequency will increase power/voltage and therefore result in an ineffective or poor unstable control loop.

To ensure that a system employing a proportional controller design or that is otherwise dependent on a monotonic system gain response of its receiver pickup voltage to the transmitter supply voltage for effective regulation of receiver output voltage, one option is to shift the transfer function to the left. This can be done by changing the reactance of the system at a given location. For example an additional capacitance can be introduced in either the transmitter or the receiver to lower the resonant frequency(s), or otherwise shift the transfer function to the left. Alternatively, the transfer function could be shifted to the right if the system was prescribed to operate on the positive slope instead of the negative slope (i.e. Qi).

FIG. 4 shows the shifted transfer function 402 compared to the previous function 308. The frequency operating range 306 is now again in a monotonic region of the transfer function, so frequency is again directly related to the output voltage and/or power transfer.

The non monotonic region that occurs in the second transfer function 308 may occur in many IPT transmitters, especially where frequency modulation is used for regulating. The transmitting coil need not be resonant, but the system gain frequency response curve needs to be able to be utilised for regulating action. In most cases this will require resonance in the system to create a region of sufficient monotonic gradient for effective regulation.

In such systems the phenomenon may be due to relatively low equivalent load resistance (e.g. below 5 ohms); ferrite shielding material that has a saturation level or other non-linear proportionality within the range of load current and coupling factor (equivalent to the range of separation between the Tx & Rx coils) being operated within; or relatively high coupling factor conditions (i.e. closely aligned or separated coils).

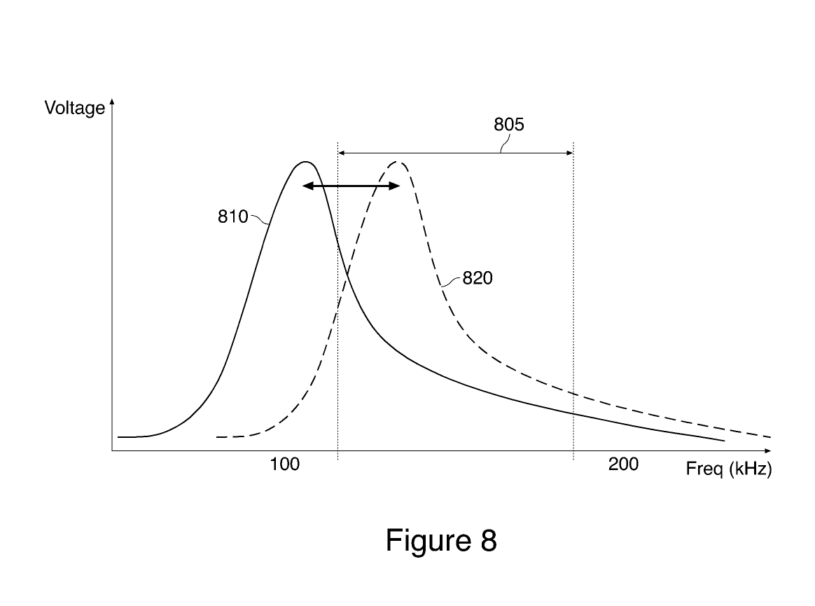

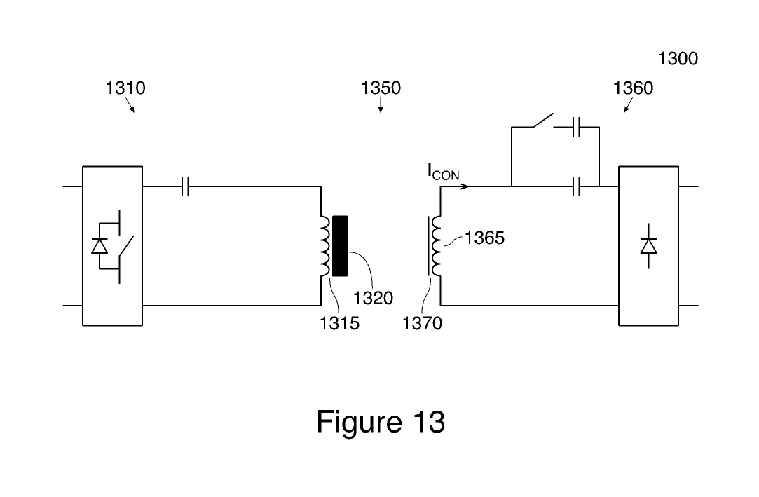

Referring to FIGS. 8 and 13, a further IPT system frequency/gain response curve altering phenomenon is described. FIG. 13 shows an IPT system 1300 having an IPT transmitter 130 inductively coupled over an air gap 1350 to an IPT receiver 1360. As already described the transmitter and receiver each have respective transmitting and receiving coils 1315 and 1365. These will typically also be associated with respective preamble material 1320 and 1370, usually in the form of ferrite plates and/or cores around which the coils are wound. The permeable material concentrates the strength and increases the effect of magnetic fields or flux associated with electric currents in the coils. The presence of such a core can increase the magnetic flux density by a factor of thousands compared to what it would be without the core. However should the ferrite saturate, this will affect the flux density and thus the apparent inductance of the coil it is associated with. This can be an issue particularly for receiver coil arrangements in Smartphone and other consumer electronics devices in which miniaturisation is important and often resulting in small or thin ferrite compared with the transmitter ferrite. This is illustrated in FIG. 13 by the relatively thin ferrite 1370 in the receiver 1360 compared with the thicker ferrite 1320 in the transmitter 1310 which will typically be of a larger size and able to accommodate more ferrite even in consumer electronics applications.

The saturation of the receiver coil 1365 is dependent on the coil current I_{coil} and the amount (and/or shape and/or total permeability) of permeable material 1370. As the receiver ferrite 1370 approaches saturation with increasing coil current, the apparent inductance L_{RX} of the receiver coil begins to fall. This results in the system frequency/gain curve moving to the right as shown in FIG. 8 as a result of reduced inductive reactance in the resonance relationship (f=1/2.pi.sqrt(L . C)). The “unsaturated” curve 810 has a resonant peak at around 100 kHz, however after saturation of the thin ferrite core 1370 the “saturated” frequency/gain curve 820 has been shifted right with a resonant frequency around 140 kHz. Note that this “right shift” phenomenon does not necessarily result in the double peak phenomenon described above, which will also be affected by the selected inductance of the receiver coil and other parameters previously noted. In other words the double peak and right shift phenomena may be independent or overlapping dependent on the IPT system design and current operating parameters.

As with the dual peak phenomenon described in FIG. 3, as a consequence of the right shifted transfer function 820, a simple up/down frequency control methodology may fail to reach its desired operating point if the frequency operating range 805 of the transmitter overlaps with the right shifted resonant peak—ie the frequency response becomes non-monotonic over the control range. The controller 8 of FIG. 1 will expect a negative gradient and will therefore increase frequency if less power/voltage is required by the receiver 3. To the left of peak of the right shifted response 820, increased frequency will increase power/voltage and therefore result in an ineffective or poor unstable control loop.

To ensure that a system employing a proportional controller design or that is otherwise dependent on a monotonic system gain response of its receiver pickup voltage to the transmitter supply voltage for effective regulation of receiver output voltage, one option is to shift the transfer function to the left—essentially back to where it was 820 with an unsaturated ferrite core. This can be done by changing the reactance of the receiver, for example an additional capacitance can be introduced in the receiver to lower the resonant frequency(s), or otherwise shift the transfer function to the left. Alternatively, the transfer function could be shifted to the right if the system was prescribed to operate on the positive slope instead of the negative slope (i.e. Qi).

The emergence and extent of the double peak and right shift effects on the voltage- or power-frequency system gain response curve affect a level of control viability of the system. In other words if these effects result in a non-monotonic region over the frequency control range then the power control loop may become unstable. The greater the changes to the response curve the lower the level of control viability may become—as discussed this will depend on system design parameters as well as operating parameters. Where this level of control viability falls below a threshold, the system can recover control viability or stability by adjusting reactances in the system. Where coil inductance is the main contribution (double peak phenomenon), the level of control viability being below the threshold corresponds to a coil current through a transmitting or receiving coil of the system exceeding a predetermined level of current in relation to inductance value of the coil. Where saturation of ferrite is the main contribution (right shifted peak phenomenon), the level of control viability being below the threshold corresponds to coil current being above a predetermined level of current in relation to permeability of the permeable material associated with the coil. Although less likely in practical systems, saturation of the permeable material associated with the transmitter coil may also affect the voltage- or power-frequency system gain response of the IPT system, and therefore in some circumstances coil current in the transmitter coil may also need to be considered/monitored.

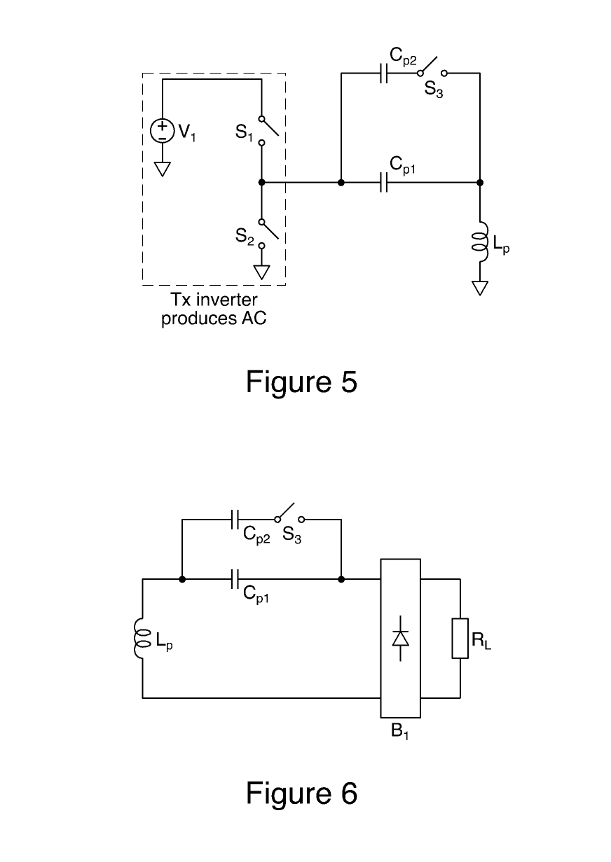

In order to address one or both of the double peak and right shift phenomena, a switched capacitance may be implemented in a transmitter as shown in FIG. 5 or in a receiver as shown in FIG. 6. In either case an additional capacitance C_{P2} is switched in parallel (or in series depending on the configuration) with fixed capacitance C_{P1} when the instability condition is identified or predicted to occur. The additional capacitance then changes the resonant frequency(s) as discussed above.

The value of the switched capacitance C_{P2} may be determined by experiment or estimating the amount by which the undesired secondary resonance of FIG. 3 or the right shifted resonance of FIG. 8 exceeds the desired resonance frequency, and using a value that is resonant (in desired conditions) at a frequency below the desired frequency by an identical amount.

The changes in the frequency/gain response (either or both as illustrated in FIGS. 3 and 8) are dependent on both changes in operating parameters such as coil currents and coupling factor as well as system design parameters such as coil inductances and ferrite permeability. Therefore the particular parameter values or thresholds at which these phenomena emerge will depend on the IPT system used and its expected operating range. Using experimentally achieved data for an IPT system, or a theoretically derived model, changes in the system frequency/gain curve for different systems and their operating points can be determined in advance. Operating points affecting these response curve changes include the coupling factor, receiver coil current and load power. Therefore a lookup table of these operating parameters can be employed in order to predict when an undesirable change in the response curve is about to occur. Once a threshold is reached for any of the operating parameters, the transmitter or receiver can change the system reactance in order to shift the response curve to the left in order to avoid a non-monotonic region being used for the Qi regulation control loop (or other control or operational purposes).

For the right shift phenomenon due to thin ferrite, each of the required operating parameters can be estimated from the load current, being directly related to the coil current by the rectification function, and being directly related to the load power for a given/known load voltage (typically 5V in Qi systems) and an effective load resistance which affects the system damping factor. Therefore a simple control methodology is simple to switch in the additional capacitor C_{P2} of FIG. 5 or 6 when the load current exceeds a threshold (predetermined according to the IPT system design and expected range of operating parameters), and to switch out the capacitor additional C2p when the load current falls below the threshold. A suitable hysteresis may be included to avoid instability around the threshold value(s).

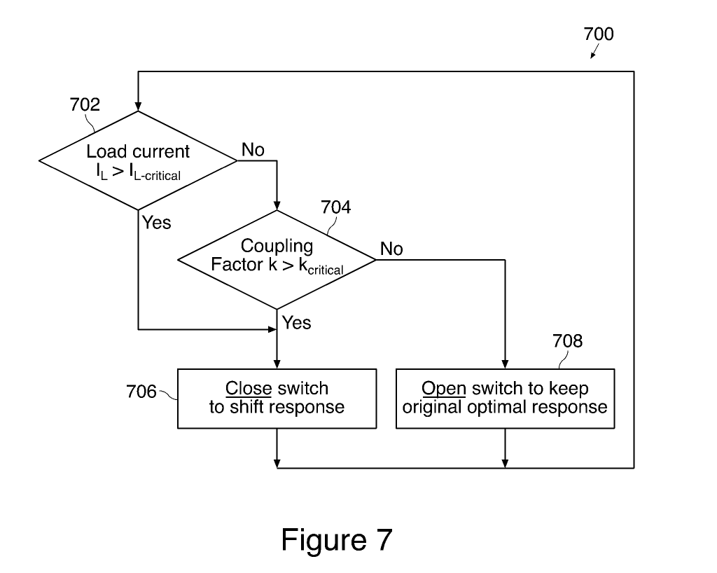

A control methodology 700 is shown in FIG. 7 in order to address the dual peak phenomenon associate with coil inductance. This additionally requires monitoring of the coupling factor. If the load current 702 is above the threshold I_{L-critical}, or if the coupling 704 is above the threshold k_{critical}, then switch S₃ is closed 706 to enable C_{P2}. Otherwise switch S₃ is opened 708 to disable C_{P2}.

The level of coupling may be determined during the initialisation/handshake when the receiver is first identified by the receiver. Alternatively the coupling may be determined by measuring the power factor of the voltage and current in the transmitter coil or the receiver coil. The ratio of real component of power to the apparent power, or alternatively the phase angle difference between the voltage and current in the coil (both for the fundamental frequency component of operation) can be used.

The power factor gives an indication of the inductance appearing between the transmitter coil terminals and the receiver coil terminals, which approaches zero when the coils have a high coupling factor (the same as a direct wired connection). With high coupling factor and thus the inductance between the terminals approaching zero, the power factor approaches unity (low reactive component, high usable real component). The opposite holds—with low coupling factor and thus the inductance between the terminals having a significant finite value, the power factor approaches zero (high reactive component, low usable real component of power).

The load current can be measured directly by the receiver controller 12 or may be estimated by the transmitter controller 8.

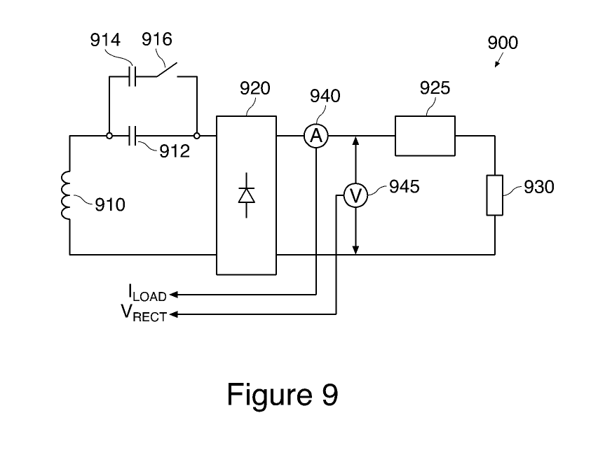

Conveniently the Qi 1.1 standard requires both the load current l_{load} and an output voltage of the receiver be monitored. FIG. 9 shows a circuit diagram of a Qi 1.1 compliant IPT receiver 900 including receiver coil 910, tuning capacitor 912, and power conditioning circuitry 920. A load 930 is coupled to the output of the power conditioning circuitry 920 via an LDO 925 used for regulation of the load voltage. The load current l_{load} is typically monitored by a current transformer 940 and is transmitted to the IPT transmitter via a back scatter communications channel. l_{load} is used by Qi based systems for a power accounting based foreign object detection algorithm, in which the transmitter compared the power transmitted against to load power in order to determine whether sufficient power is “missing” to suggest a metallic foreign object being heated. As the load voltage is regulated to 5V for the Qi system, the load power can be accurately calculated from the l_{load} values. A Qi receiver will also typically monitor the rectification voltage V_{rect} using a voltage sensor 945 across the rectified output of the power conditioner 920. This voltage V_{rect} is compared with a desired set point (eg 5V) and if it is higher, a CEP packet request for the transmitter to reduce power is sent. Similarly when Vrect falls below the set point a CEP request is sent to the transmitter to reduce power.

The l_{load} values already monitored in Qi 1.1 compliant receivers may therefore conveniently be used to control the system reactance control embodiments described above. For example a receiver system reactance control capacitor 914 may be switching in/out as the load current l_{load} rises above/falls below a threshold. Alternatively a corresponding transmitter side system reactance control capacitor (Cp2 in FIG. 5) may be controlled using the l_{load} values sent back to the transmitter for operation of the power accounting control algorithm.

Therefore the l_{load} values already employed by Qi compliant receivers may be used to predict control instability or in other words determine a level of control viability for the inductive power transfer system within the predetermined control range (typically around 110 kHz to 170 kHz for Qi 1.1), and to adjust the reactance of the system if this level of control viability falls below a threshold. In some embodiments described this corresponds to the measured load current l_{load} exceeding a threshold determined according to the design and operating parameters of the system.

If the entire frequency operating range of the transfer function is monotonic that is an example of a high level of control viability. Whereas any non monotonic region within frequency operating range of the transfer function is an example of a low level of control viability. As such the level of coupling, load current or other measures can be used to predict the level of control viability in a given scenario. A threshold level of control viability for employing the switched capacitor will need to balance the need for efficiency during normal operation and the required degree of stability or robustness of control. The actual thresholds l_{L-critical}, k_{critical} may be determined by experiment or estimation depending on the requirements of the application.

Alternatively the transmitter may signal to the receiver (or vice versa) when operating conditions are likely to result in the instability mentioned above. For example in the Qi standard v1.2.1 standard, a flag can be sent from the transmitter to the receiver called ‘Not Res Sens.’ In part 4 it mentions that this flag should be set to zero when a Power Transmitter enables frequency control below a frequency of 150 kHz and a Maximum Power value greater than 5 W.

Thus the ‘Not Res Sens.’ flag (or any similar categories indicating a non-monotonic response condition) can be used as an indication of a level of control viability by a receiver to predict whether a transmitter is going to use frequency modulation in conditions that may give rise to the problem of shifted or secondary resonance, and enable the resonance peak shifting method mentioned earlier.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A method comprising:
determining a level of control viability for an inductive power transfer system within a predetermined control range; and
adjusting the reactance of the inductive power transfer system if the level of control viability within the predetermined control range is below a threshold.

2. The method in claim 1 wherein the predetermined control range is a frequency range and the level of control viability relates to a frequency control function based on the system gain.

3. The method in claim 2 further comprising
regulating a transfer of power between an inductive power transmitter and an inductive power receiver of the inductive power transfer system by adjusting the frequency of a magnetic field coupled to the transmitter and the receiver within the predetermined frequency control range.

4. The method of claim 2 wherein the level of control viability being below the threshold corresponds to a coil current through a transmitting or receiving coil of the system exceeding a predetermined level of current to permeability of a permeable material associated with the coil.

5. The method of claim 4, wherein coil current being above the predetermined level of current to permeability of a permeable material associated with the coil is determined when a load current of an inductive power receiver is measured above a permeable material set threshold.

6. The method of claim 4 wherein adjusting the reactance of the inductive power transfer system causes the frequency control function to shift lower in frequency.

7. The method in claim 1 wherein the level of control viability depends on whether the control function is monotonic with the predetermined control range.

8. The method in claim 4 wherein the control function is determined as non monotonic with the predetermined control range if a coupling between a receiver and transmitter of the system is above a threshold, a load current above a threshold and/or a non-monotonic response condition has been determined.

9. The method in claim 4 wherein the non-monotonic response condition corresponds to a Not Res Sens flag equal to zero.

10. A method of operating an inductive power transceiver when coupled to a second inductive power transceiver; the method comprising:
monitoring a system control function of the first and second inductive power transceivers using predetermined operating parameters;
regulating power transferred through the inductive power transceiver by adjusting the operating point of the system within a predetermined range of the system control function;
adjusting the reactance of the first or second inductive power transceiver if one or more of the predetermined operating parameters exceeds a threshold.

11. The method of claim 10 wherein the system control function is a frequency control function of the system gain.

12. The method of claim 11 wherein adjusting the operating point of the system comprises adjusting the frequency of a magnetic field coupled between the transceivers within the predetermined frequency control range.

13. The method of claim 10, wherein the predetermined operating parameters comprise a load current of a said inductive power receiver.

14. The method of claim 13, wherein the load current threshold is dependent on the inductance of a coil of the first or second transceiver and/or the permeability of a permeable material associated with a coil of the first or second transceiver.

15. The method of claim 10, wherein the predetermined operating parameters comprise power factor as a vector ratio of the voltage to current in a coil of the first or second transceiver.

16. A method comprising:
determining whether a inductive power transfer system exhibits a monotonic control function with a predetermined control range; and
detuning the inductive power transfer system if the control function is non monotonic with the predetermined control range.

17. An inductive power transmitter comprising:
a power transmitter coil;
an adjustable reactance configured to connect to the coil;
a controller configured to determine whether a control function is monotonic a predetermined control range and adjust the reactance if it is not.

18. An inductive power receiver comprising:
a power receiver coil;
an adjustable reactance configured to connect to the coil;
a controller configured to determine whether a control function is monotonic a predetermined control range and adjust the reactance if it is not.

19. The transmitter in claim 17 or the receiver in claim 18 wherein the adjustable reactance comprises a switchable capacitor in parallel with a fixed capacitor.
